(19) United States
(12) Patent Application Publication
(10) Pub. No.: US 2005/0147785 A1
(43) Pub. Date: Jul. 7, 2005

(54) Nonwoven loop material and process and products relating thereto

(76) Inventors: Jung Yeul Ahn, Chungcheongnam-do (KR); Charles Edward Bolian II, Buford, GA (US); JeaSeung Chin, SuWon-City (KR); Brian Stephen Forbes, Alpharetta, GA (US); SooGyung Jung, Seoul (KR); ByungSoo Kim, Kimcheon-City (KR); Jin Hee Lee, Taejon-City (KR); Xin Ning, Alpharetta, GA (US); KueYoung You, Anyang-City (KR)

Correspondence Address: KIMBERLY-CLARK WORLDWIDE, INC., 401 NORTH LAKE STREET, NEENAH, WI, 54956, US

(21) Appl. No.: 11/070,650

(22) Filed: Mar. 2, 2005

Related U.S. Application Data
(62) Division of application No. 10/260,955, filed on Sep. 30, 2002.

(51) Int. Cl. B32B 3/02; D04H 11/00; D05C 17/00

(52) U.S. Cl. 428/92; 442/327; 264/211.14

(57) ABSTRACT

The present invention provides nonwoven fiber materials, and methods for making the same, useful for loop materials in hook and loop mechanical attachment systems, the nonwoven materials having crimped monocomponent fibers having substantially circular cross sections, and the webs may further contain uncrimped fibers. The invention also provides disposable articles comprising nonwoven loop materials including disposable personal care absorbent articles such as diapers, feminine care sanitary napkins, and adult incontinence articles, and disposable protective articles such as surgical drapes and gowns and other protective apparel.

This application is a divisional of application Ser. No. 10/260,955 entitled “NONWOVEN LOOP MATERIAL AND PROCESS AND PRODUCTS RELATING THERETO” and filed in the U.S. Patent and Trademark Office on Sep. 30, 2002.

### TECHNICAL FIELD

The present invention generally relates to the field of nonwoven materials and webs, and processes for manufacturing the same. More specifically, the present invention is related to crimped fiber nonwoven materials useful as a loop material in mechanical attachment systems, such as a hook and loop mechanical attachment system.

### BACKGROUND OF THE INVENTION

Mechanical fastening systems, such as the type referred to as “hook and loop” fastener systems, have become widely used in various consumer and industrial applications. A few examples of such applications include disposable personal care absorbent articles, protective garments, clothing, sporting goods equipment, and a wide variety of other miscellaneous articles. Typically, such hook and loop fastening systems are employed in situations where a refastenable connection between two or more materials or articles is desired. These mechanical fastening systems have in many cases replaced other conventional devices used for making such refastenable connections, such as safety pins, buttons, buckles, zippers, and the like.

Mechanical fastening systems typically employ two components, a “male” or hook type component and a “female” or loop type component. The hook component usually includes a plurality of semi-rigid, hook-shaped elements anchored or connected to a base material. The loop component generally as known in the art includes a resilient backing material from which a plurality of loops project. The hook-shaped elements of the hook component are designed to engage the loops of the loop material, thereby forming mechanical attachments between the hook and loop elements of the two components. These mechanical attachments function to prevent separation of the respective components during normal use.

Mechanical fastening systems can be advantageously employed in disposable personal care absorbent articles, such as disposable diapers, disposable garments, disposable feminine care products, disposable incontinence products, and so forth. In addition, mechanical fastening systems may be beneficially used in mechanical attachment systems for other disposable articles as surgical gowns and surgical drapes, patient exam gowns, industrial workwear and cleanroom apparel. Because such disposable products are intended as single-use items to be discarded after a relatively short period of use, often only a few hours, it is important to reduce the overall expense of materials in the design of such products and to reduce manufacturing costs wherever possible. Thus there exists a continuing need for an inexpensive loop fastening material for a mechanical fastening system, particularly as such are used in disposable personal care absorbent articles and disposable protective articles.

### BRIEF SUMMARY OF THE INVENTION

The present invention provides a nonwoven loop material useful in disposable articles such as disposable personal care absorbent articles and disposable protective articles. In one aspect, the nonwoven loop material comprises monocomponent fibers which are helically crimped and which have a substantially circular cross section, and the nonwoven material comprises a plurality of discrete unbonded areas defined by substantially continuous bonded areas, wherein these unbonded areas comprise about 85 percent to about 50 percent of the second of first and second plane surfaces of the nonwoven loop material. The crimped fibers may comprise random copolymers of olefins. The nonwoven loop material may further comprise uncrimped fibers, in which case the majority of the uncrimped fibers is located in or on the first plane surface while the majority of the crimped fibers is located in or on the second plane surface of the material. The invention also provides a process for making a nonwoven material including the steps of providing a fiber forming thermoplastic composition, forming a plurality of molten monocomponent fibers of substantially circular cross section from the thermoplastic composition, differentially quenching the molten fibers to form crimped monocomponent fibers having substantially circular cross section, depositing the crimped fibers upon on a forming surface to form an unbonded nonwoven web, and then bonding the unbonded web with heat and pressure to form a pattern of substantially continuous bonded areas defining a plurality of discrete unbonded areas, and wherein the nonwoven material has an unbonded area of from about 85 percent to about 50 percent. In one aspect the process additionally includes providing on the forming surface a plurality of uncrimped fibers before the step of depositing the crimped fibers. The process may optionally include the step of subjecting the material to a stretching force.

The invention also provides disposable articles comprising inner and outer sides, a hook material, and a nonwoven loop material comprising at least a portion of the outer side of the article, and the nonwoven loop material further comprising helically crimped continuous monocomponent fibers of substantially circular cross section. The hook material may be located on a tab on or attached to the article, and the tab located on the article in such a way as to make the hooks easily superposable and engagable with the loop material. That is, having the tab with hook material located in such a way as to be easily placed in face-to-face relation with the loop material so that the hooks may readily engage the loop material.

The invention also provides a disposable diaper comprising a liner, outer cover, and an absorbent core disposed between the liner and outer cover, and further comprising a mechanical fastening system having a tab comprising a hook material, and a loop material, wherein the loop material comprises at least a portion of the outer cover, and further wherein the loop material has a first plane surface having a majority of uncrimped fibers and a second plane surface having a majority of helically crimped monocomponent fibers of substantially circular cross section, and wherein the second plane surface is exposed on the outer cover. In certain aspects, the loop material is thermally pattern bonded with a point bond pattern, while in other aspects the loop material is thermally pattern bonded with a point-unbonded bond pattern.

### BRIEF DESCRIPTION OF THE DRAWINGS

FIG. 1 is a top view of an exemplary embodiment of the nonwoven loop material of the present invention.

FIG. 2 is a schematic side view of an exemplary process and apparatus for producing a nonwoven web of spunbond fibers.

FIG. 3 is a partial perspective view of a pattern roll that can be used within the process of FIG. 2.

FIG. 4 is a perspective view of a disposable diaper employing the nonwoven loop material of the present invention as a loop patch.

### DEFINITIONS

As used herein and in the claims, the term “comprising” is inclusive or open-ended and does not exclude additional unrecited elements, compositional components, or method steps. Accordingly, the term “comprising” encompasses the more restrictive terms “consisting essentially of” and “consisting of”.

As used herein the term “polymer” generally includes but is not limited to, homopolymers, copolymers, such as for example, block, graft, random and alternating copolymers, terpolymers, etc. and blends and modifications thereof. Furthermore, unless otherwise specifically limited, the term “polymer” shall include all possible spatial configurations of the material. These configurations include, but are not limited to isotactic, syndiotactic and random symmetries.

As used herein the term “fibers” refers to both staple length fibers and continuous filaments, unless otherwise indicated.

As used herein the term “monocomponent” fiber refers to a fiber formed from one or more extruders using only one component. Monocomponent fibers are distinct from multicomponent fibers in that they do not comprise multiple substantially constantly positioned distinct zones of different components across the cross-section of the fiber. This is not meant to exclude fibers formed from one polymer to which small amounts of additives have been added for color, anti-static properties, lubrication, hydrophilicity, etc.

As used herein the term “multicomponent fibers” refers to fibers which have been formed from at least two component polymers, or the same polymer with different properties or additives, extruded from separate extruders but spun together to form one fiber. Multicomponent fibers are also sometimes referred to as conjugate fibers or bicomponent fibers. The polymers are arranged in substantially constantly positioned distinct zones across the cross-section of the multicomponent fibers and extend continuously along the length of the multicomponent fibers. The configuration of such a multicomponent fiber may be, for example, a sheath/core arrangement wherein one polymer is surrounded by another, or may be a side by side arrangement or other arrangements as are known in the art. By way of example, multicomponent fibers are taught in U.S. Pat. No. 5,108,820 to Kaneko et al., U.S. Pat. No. 5,336,552 to Strack et al., and U.S. Pat. No. 5,382,400 to Pike et al.

As used herein the term “nonwoven web” or “nonwoven material” means a web having a structure of individual fibers or filaments which are interlaid, but not in an identifiable manner as in a knitted or woven fabric. Nonwoven webs have been formed from many processes such as for example, meltblowing processes, spunbonding processes, air-laying processes and carded web processes.

The term “spunbond” nonwoven web or material refers to a nonwoven fiber or filament material of small diameter fibers or filaments that are formed by extruding molten thermoplastic polymer as fibers from a plurality of capillaries of a spinneret. The extruded fibers are cooled while being drawn by an eductive or other well known drawing mechanism. The drawn fibers are deposited or laid onto a forming surface in a generally random, isotropic manner to form a loosely entangled fiber web, and then the laid fiber web is subjected to a bonding process to impart physical integrity and dimensional stability. The production of spunbond fabrics is disclosed, for example, in U.S. Pat. No. 4,340,563 to Appel et al. and U.S. Pat. No. 3,802,817 to Matsuki et al.

As used herein, “pattern bonding” refers to bonding by one or more means known in the art by a means which does not bond the entire surface area of the material. As an example, thermal pattern bonding involves passing a fabric or web of fibers or other sheet layer material to be bonded between a calender roll and an anvil roll, at least one of which is heated. The calender roll is generally patterned in some way so that the entire fabric is not bonded across its entire surface. Alternatively, both rolls may be patterned. Various patterns for calender rolls have been developed for functional as well as aesthetic reasons. Examples of thermal pattern bonding include, but are not limited to, thermal point bonding patterns such as that taught in U.S. Pat. No. 3,855,046 to Hansen and Pennings, herein incorporated by reference, which is known as the “H&P” pattern and which has about a 30 percent bond area with about 200 bonds/square inch. Another exemplary thermal point bonding pattern is the expanded Hansen and Pennings or “EHP” bond pattern which produces about a 15 percent bond area. Another useful example of thermal pattern bonding is the pattern-unbonded or point-unbonded thermal bonding method described in U.S. Pat. No. 5,858,515 to Stokes et al., herein incorporated by reference, in which one or both of the calender rolls is engraved such that its surface comprises a continuous pattern of land areas defining a plurality of discrete openings, apertures or holes. Each of the openings in the surface of the roll or rolls forms a discrete unbonded area in the surface of the nonwoven web material in which the fibers of the web are substantially or completely unbonded.

### DETAILED DESCRIPTION OF THE INVENTION

Disclosed herein is a nonwoven material suitable as a loop material for a mechanical attachment system, such as a hook and loop mechanical attachment system. Also disclosed herein is a method for making the nonwoven loop material of the invention. The invention will be described with reference to the drawings illustrating certain embodiments and with reference to certain other exemplary embodiments as described hereinbelow. It will be apparent to those skilled in the art that these embodiments do not represent the full scope of the invention which is broadly applicable in the form of variations and equivalents as may be embraced by the claims appended hereto. It is intended that the scope of the claims extend to all such variations and equivalents.

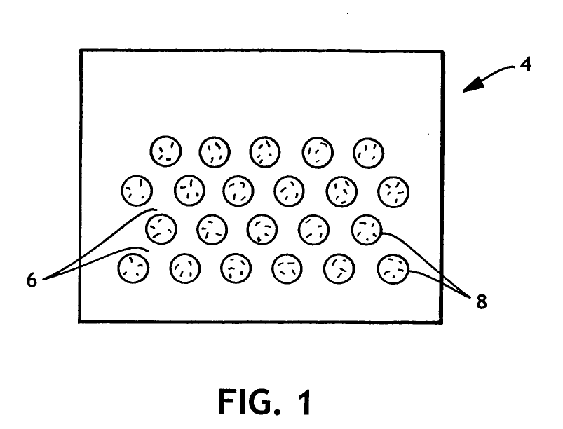

FIG. 1 is a top view which illustrates an exemplary nonwoven loop material of the invention. Use of the term “loop” is not intended to limit the loop material of the present invention to only materials in which discrete, separately formed loops of material are employed to receive and engage the hook elements of a complementary hook material. Rather, the loop material of the present invention includes fibrous nonwoven fabrics or webs in which the individual fibers are crimped fibers forming an open web structure with substantial void portions between the fibers such that the fibers function to engage the hook elements without such fibers necessarily being formed into discrete loops. Various types of hook materials and hook elements, such as inverted J shapes, inverted T shapes, and generally mushroom-shaped hooks are known in the art. Referring again to FIG. 1, the nonwoven loop material 4 comprises, in its simplest form, a nonwoven material having continuous bonded areas 6 which define a plurality of discrete, dimensionally-stabilized unbonded areas 8. Within the continuous bonded areas 6, the fibers of the nonwoven material are bonded or fused together and desirably are substantially non-fibrous and may, for example, comprise a film-like area. In the unbonded areas 8 the fibers of the nonwoven material are substantially or completely free of bonding or fusing such that they retain their open fibrous structure. The nonwoven loop material of the invention may have basis weights ranging from about 20 to about 100 grams per square meter (“gsm”), and more particularly from about 40 gsm to about 80 gsm. In a further aspect, the nonwoven loop material may have a fabric thickness or bulk of from about 0.4 millimeter to about 1.2 millimeter, or greater.

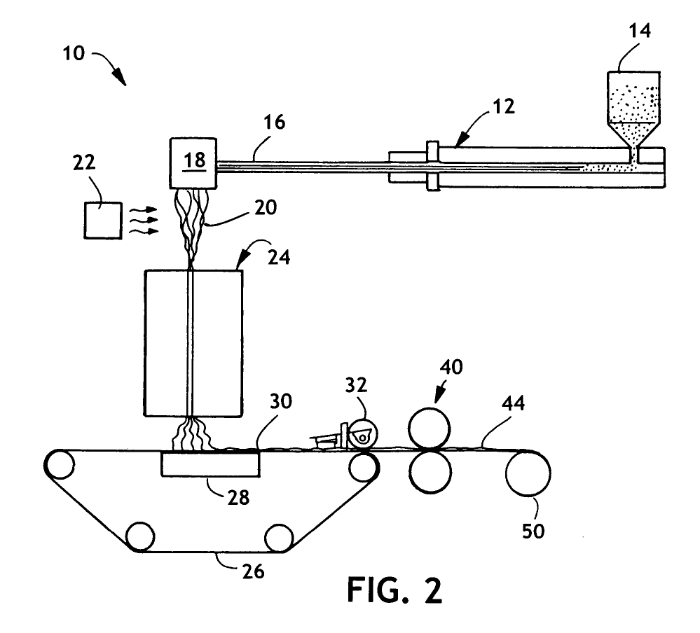

FIG. 2 schematically illustrates a process for forming the nonwoven loop material of the present invention. In FIG. 2, process line 10 includes an extruder 12 for melting and extruding polymer fed into the extruder 12 from polymer hopper 14. The polymer is fed from extruder 12 through polymer conduit 16 to a spinneret 18. The spinneret 18 has defined openings that are commonly arranged in one or more rows. The spinneret openings form a downwardly extending curtain of fibers 20 when molten polymer is extruded through the spinneret.

Polymers suitable for the present invention include the known polymers suitable for production of nonwoven webs and materials such as for example polyolefins, polyesters, polyamides, polycarbonates and copolymers and blends thereof. Suitable polyolefins include, but are not limited to, polyethylene, e.g., high density polyethylene, medium density polyethylene, low density polyethylene and linear low density polyethylene; polypropylene, e.g., isotactic polypropylene, syndiotactic polypropylene, blends of isotactic polypropylene and atactic polypropylene; polybutylene, e.g., poly(1-butene) and poly(2-butene); polypentene, e.g., poly(1-pentene) and poly(2-pentene); poly(3-methyl-1-pentene); poly(4-methyl-1-pentene); and copolymers and blends thereof. Suitable copolymers include, but are not limited to, random and block copolymers prepared from two or more different unsaturated olefin monomers, such as ethylene/propylene, butylene/propylene and ethylene/butylene copolymers. Exemplary copolymers of olefins include those containing from about 99.5 to about 90 percent, by weight, propylene and from about 0.5 to about 10 percent, by weight, of ethylene or another alpha-olefin co-monomer having at least 4 carbon atoms such as 1-butene, 4-methyl-1 pentene, 1-hexene, or 1-octene.

Suitable polyamides include, but are not limited to, nylon 6, nylon 6/6, nylon 4/6, nylon 11, nylon 12, nylon 6/10, nylon 6/12, nylon 12/12, copolymers of caprolactam and alkylene oxide diamine, and the like, as well as blends and copolymers thereof. Suitable polyesters include, but are not limited to, polyethylene terephthalate, polybutylene terephthalate, polytetramethylene terephthalate, polycyclohexylene-1,4-dimethylene terephthalate, and isophthalate copolymers thereof, as well as blends thereof.

The exemplary process line 10 also includes a quench blower 22 positioned adjacent the curtain of fibers 20 extending from the spinneret 18. Air from the quench air blower 22 quenches the fibers 20 extending from the spinneret 18. The quench air can be directed from one side of the curtain of fibers as shown in FIG. 2, or both sides of the curtain of fibers. As used herein, the term “quench” generally means reducing the temperature of the fibers using a medium that is cooler than the fibers such as using, for example, chilled air streams, ambient temperature air streams, or slightly to moderately heated air streams.

In order to produce crimped fibers, a differential quench is applied to the fibers 20 when they are substantially molten. As used herein, “differential quench” means applying the quenching medium in such a fashion as to impart differential stress from one side of the cross section of a fiber to the other side while the fibers are being drawn from the spinneret. Imparting differential stress causes the fibers to twist or curl, i.e. “crimp”, in a helical fashion. The differential stress may be created by, for example, use of a single quench air blower as shown in FIG. 2 which delivers the quench air at a relatively high air velocity, such as for example at about 600-700 feet per minute (about 183-213 meters per minute). The quench air velocity required in a given process to impart helical crimp may be higher or lower and will depend on a number of processing factors such as for example polymer selection, polymer melt temperature, quench air temperature, fiber velocity, distance of the quench air blower to the curtain of fibers and number of spinneret holes (and thus fibers) per unit area.

Alternatively, where the quenching medium is directed at the curtain of fibers from both sides, the differential stress may be created by setting the quench blower on one side of the curtain of fibers at a significantly higher air velocity, and/or significantly cooler air temperature, than the quench blower on the other side of the curtain of fibers. Differential quenching of molten fibers is disclosed, for example, in U.S. Pat. No. 5,427,845 to Sawyer et al., herein incorporated by reference. Although it is known in the art to produce helically crimped bicomponent fibers or helically crimped fibers having shaped or lobed cross sections, neither of these expedients is required to produce helical crimp when differential quenching is utilized, and bicomponent and shaped fiber processes require more specialized fiber production apparatus than for monocomponent circular fibers.

As stated above, a wide variety of polymers and copolymers may be utilized to form the crimped monocomponent fibers by differentially quenching the molten fibers. Depending on processing variables such as melt temperature and available quench air temperature and quench air flow rate, it may be desirable to select polymers which more readily form crimped fibers under differential quenching conditions. In this regard, copolymers, especially copolymers of olefins such as for example random and block copolymers prepared from two or more different unsaturated olefin monomers, such as for example random copolymers of propylene and ethylene, and random copolymers of propylene and butylene, readily develop crimp under differential quenching conditions.

Referring again to FIG. 2, a fiber draw unit or aspirator 24 to receive the quenched fibers is positioned below the spinneret 18 and the quench blower 22. Fiber draw units or aspirators for use in melt spinning polymers are well known in the art. Suitable fiber draw units for use in the method of the present invention include, but are not limited to, linear fiber aspirators of the types shown in U.S. Pat. No. 3,802,817 to Matsuki et al. and U.S. Pat. Nos. 4,340,563 and 4,405,297 to Appel et al., all herein incorporated by reference. Generally described, the fiber draw unit 70 includes an elongate vertical passage through which the fibers are drawn by aspirating air entering from the sides of the passage and flowing downwardly through the passage. Aspirating air is supplied by a blower (not shown). The fiber draw unit 24 attenuates the fibers, that is, applies a downward force upon the fibers thereby reducing their diameter from the diameter initially extruded through the spinneret 18. Generally speaking, the fibers may have a denier-per-fiber (“denier” or “dpf”) of about 1 to 10 denier, and desirably are about 2 to about 6 denier. Denier is a measure of fiber mass to unit length wherein 1 denier equals 1 gram per 9000 meters of fiber.

An endless foraminous forming surface 26 is positioned below the fiber draw unit 24 to receive the fibers from the outlet opening of the fiber draw unit 24. A vacuum source 28 positioned below the foraminous forming surface 26 may be beneficially employed to pull the attenuated fibers onto foraminous forming surface 26. The fibers received onto foraminous forming surface 26 comprise a nonwoven web 30 of loose continuous fibers, which are initially consolidated using consolidation means 32 to assist in transferring the web to a bonding means. Consolidation means 32 may desirably be, for example, a mechanical compaction roll as is known in the art.

The process line 10 further includes a pattern bonding assembly 40 such as the thermal pattern calender rolls shown in FIG. 2 which are used to thermally bond the nonwoven web into a coherent bonded web 44. As described above, pattern bonding is a process by which the fibers are fused together such as by the application of heat and pressure to form bonds. The pattern selected may be a point bonding pattern or point-unbonded pattern, depending on particular end-use application and the tolerance for fiber “pull-outs” for that application. Upon disengagement or removal of the hook material during normal use of a hook and loop fastening system the fibers acting as loops with which the hooks are engaged may have a tendency, to greater or lesser extent, to be pulled out of the fibrous nonwoven web structure. An exemplary pattern-unbonded or point-unbonded thermal bonding method is described in U.S. Pat. No. 5,858,515 to Stokes et al., herein incorporated in its entirety by reference. The pattern-unbonded method described in Stokes et al. reduces fiber pull-outs and therefore is a particularly useful bonding method for applications where it is desirable to minimize occurrence of fiber pull-outs.

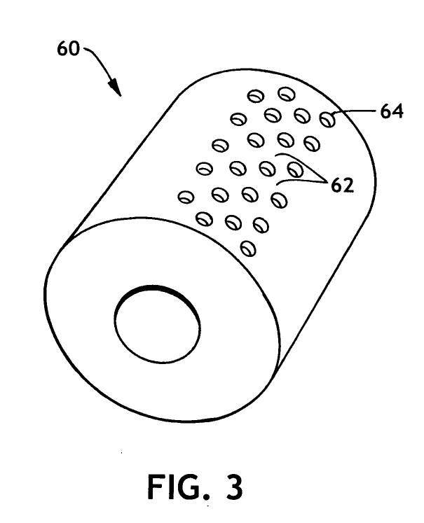

In point-unbonded bonding, one or both of the calender rolls is engraved such that its surface comprises a continuous pattern of land areas defining a plurality of discrete openings, apertures or holes. Each of the openings in the surface of the roll or rolls defined by the continuous land areas forms a discrete unbonded area in the surface of the nonwoven web material in which the fibers of the web are substantially or completely unbonded. In FIG. 3 is shown an exemplary calender roll 60 having a point-unbonded surface engraving having continuous land areas 62 defining a plurality of discrete openings or apertures 64. The size, shape, number and configuration of openings 64 can be varied to meet the particular end-use requirements of the nonwoven loop material. The degree of bonding imparted to the nonwoven loop material by the continuous land areas 62 can be expressed as a percent bond area, i.e. the portion of the area of at least one surface of nonwoven loop material occupied by the continuous bonded areas designated in FIG. 1 by reference numeral 6. Alternatively this may be expressed in terms of the percent unbonded area, that is, the percent portion of the nonwoven loop material comprising loose fibers available to act as loops. Stated generally, the lower limit on the percent bond area suitable for a nonwoven loop material (or, alternatively the upper limit on the percent unbonded area) is the point at which fiber pull-out excessively reduces the surface integrity and durability of the pattern-unbonded material. For applications where a low to moderate amount of fiber pull-outs is acceptable, this percent unbonded area may suitably be as high as about 85 percent. For other applications where pull-outs are less desirous nonwoven loop materials having percent unbonded areas ranging from about 80 percent to about 50 percent have been found suitable.

Although FIG. 2 and process line 10 are hereinabove described with respect to a single fiber spinning apparatus or “spin bank”, in certain embodiments more than one spin bank may be employed. For example, the process line may employ multiple spin banks wherein each spin bank produces crimped fibers by the use of differential quench, and at each spin bank the crimped fibers from each subsequent (or “downstream”) bank are deposited at the foraminous forming surface atop the fibers of the previous (or “upstream”) spin bank, and after the last spin bank has deposited its fibers the web is then transported further downstream through the consolidation means and through a bonding assembly as described above. However, where multiple spin banks are employed it should be noted that it is not necessary that all of the spin banks form crimped fibers. Rather, it is only necessary that the surface of the nonwoven loop material which is intended to be used to engage the hooks of the mechanical fastening system contain crimped fibers.

In addition, other variations are possible. Where multiple spin banks are employed the individual spin banks may all spin the same polymer, such as polypropylene, or a random copolymer of propylene and ethylene, or a polyester. Alternatively, all the spin banks need not all use the same polymer, for example, and additionally the individual spin banks need not produce fibers of the same size. As an example of an embodiment which combines the foregoing, a two spin bank process line may be utilized wherein the first or upstream spin bank spins uncrimped polypropylene fibers and the second or downstream spin bank spins crimped random copolymer fibers, the second spin bank depositing the crimped fibers atop the uncrimped fibers from the first spin bank. The uncrimped fibers may for example be from about 2 to about 5 denier and the crimped fibers from about 3 to about 6 denier. The web, containing fibers from the two spin banks, is then transported further downstream through the consolidation means and bonding assembly to form a nonwoven loop material having a majority of the crimped fibers on one surface of the material, and having a majority of the uncrimped fibers on the opposite surface of the material. It should also be noted that although the individual spin banks may produce fibers at about equal mass production rates, they may alternatively produce the fibers at significantly unequal mass production rates wherein one spin bank produces, for example, two thirds of the basis weight of the final nonwoven loop material while the other spin bank produces one third.

Referring again to FIG. 2, the process line 10 further includes a winding roll 50 for taking up the bonded web 44. While not shown here, various additional potential processing and/or finishing steps known in the art such as for example web slitting, stretching, treating, printing on the nonwoven loop material, and/or other operations may be performed without departing from the spirit and scope of the invention. As an example, it may be highly desirable to print the nonwoven loop material with color graphics to provide a more visually appealing material. In addition, as an alternative to taking the nonwoven web up on winding roll 50, the nonwoven web may be directed immediately to various converting or integrated product forming operations.

As another particular example, it may be beneficial to subject the nonwoven material to a small amount (about 5 percent to about 15 percent) of stretching to further provide additional loft or bulk to the fibers in the unbonded areas, allowing for increased engageability with hooks. This stretching may be performed in either the material longitudinal direction (that is, the direction in which the material is produced, also known as the machine direction) or in the material transverse direction (the direction perpendicular to the direction of material production, also known as the cross-machine direction) and may be accomplished by means as are well known in the art such as for example use of tenter frames for transverse stretching, or by draw speed differential between in a series of driven nipped rollers for longitudinal stretching. As a specific example, about a 10 percent longitudinal stretching force may be applied to the material by transporting the material through a series of driven nipped rollers wherein the second pair of driven nipped rollers is driven at a speed 10 percent faster than first pair of rollers.

The nonwoven loop material of the invention is useful in a mechanical attachment system in a wide variety of disposable personal care absorbent articles and disposable protective articles. Disposable personal care absorbent articles include but are not limited to infant and child care absorbent articles such as diapers and training pants, disposable swimwear, adult care incontinent garments, feminine care articles such as sanitary napkins, bandages and wound dressings, and the like. Disposable protective articles include but are not limited to such articles as surgical gowns and surgical drapes, patient examination gowns, industrial workwear and cleanroom apparel. Such disposable personal care and protective articles generally have a body facing side which is worn or placed against or towards the body of the user and a non-body facing side facing away from the body of the user. The nonwoven loop material of the invention, when used as part of a mechanical attachment system for such disposable personal care and protective articles, would generally be placed on or attached to the outer or non-body facing side of the article, or alternatively the outer or non-body facing side of the article may be composed wholly of the nonwoven loop material of the invention. The hook material would generally be placed on or comprise a tab on the article which is conveniently located on the article such that the user or wearer is able to superpose the hook tab with the nonwoven loop material, that is, is easily able to place the hook tab in face to face relation with the nonwoven loop material, such that hook components can engage the fibers of the loop material.

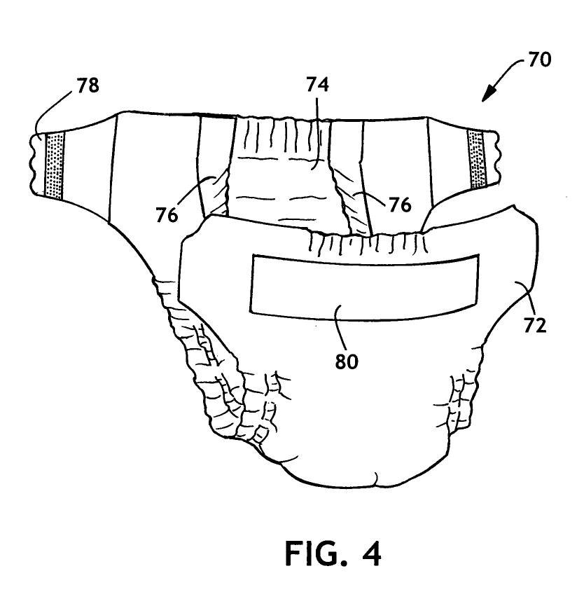

Turning to FIG. 4 there is shown an exemplary personal care article such as the diaper 70. Diaper 70, as is typical for most personal care absorbent articles, includes a liquid permeable body side liner 74, i.e., a body-facing or inner side, and a liquid impermeable outer cover 72, i.e., a non-body facing or outer side. Various woven or nonwoven fabrics can be used for body side liner 74 such as a spunbond nonwoven web of polyolefin fibers, or a bonded carded web of natural and/or synthetic fibers. Outer cover 72 is formed of a thin liquid barrier material such as for example a spunbond-meltblown layer, spunbond-meltblown-spunbond layer, or a thermoplastic polymer film layer. A polymer film outer cover may be embossed and/or matte finished to provide a more aesthetically pleasing appearance, or may be a laminate formed of a woven or nonwoven fabric and thermoplastic film. Outer cover 72 may optionally be composed of a “breathable” material that is permeable to vapors or gas yet substantially impermeable to liquid, such as is known in the art. Examples of outer cover materials include but are not limited to those disclosed in U.S. Pat. No. 6,309,736 to McCormack et al., the disclosure of which is incorporated herein by reference in its entirety

Disposed between liner 74 and outer cover 72 is an absorbent core (not shown) formed, for example, of a blend of hydrophilic cellulosic wood pulp fluff fibers and highly absorbent gelling particles (e.g., superabsorbent material). Diaper 70 may further include optional containment flaps 76 made from or attached to body side liner 74. Suitable constructions and arrangements for such containment flaps are described, for example, in U.S. Pat. No. 4,704,116 to Enloe, the disclosure of which is incorporated herein by reference in its entirety. Still further, the diaper can optionally include additional elements known to those skilled in the art, including but not limited to, elasticized leg cuffs, elastic waist band, and so forth.

To secure the diaper 70 about the wearer, the diaper will have some type of fastening means attached thereto. As shown in FIG. 4, the fastening means is a hook and loop fastening system including hook elements 78 attached to the inner and/or outer surface of outer cover 72 in the back waistband region of diaper 70 and one or more loop elements or patches 80 made from the nonwoven loop material of the present invention attached to the outer surface of outer cover 72 in the front waistband region of diaper 70. The nonwoven loop material can be secured to outer cover 72 of diaper 70 by known attachment means, including but not limited to adhesives, thermal bonding, ultrasonic bonding, or a combination of such means. As an alternative embodiment, the nonwoven loop material may cover substantially all or all of the outer surface of outer cover 72. An example of this would be an outer cover material constructed of a thermoplastic film/nonwoven loop material laminate.

While various patents have been incorporated herein by reference, to the extent there is any inconsistency between incorporated material and that of the written specification, the written specification shall control. In addition, while the invention has been described in detail with respect to specific embodiments thereof, it will be apparent to those skilled in the art that various alterations, modifications and other changes may be made to the invention without departing from the spirit and scope of the present invention. It is therefore intended that the claims cover all such modifications, alterations and other changes encompassed by the appended claims.

1. A process for making a nonwoven material comprising the steps of:
a) providing a fiber forming thermoplastic polymer composition;
b) forming a plurality of molten monocomponent fibers from said thermoplastic polymer composition, said molten monocomponent fibers having a substantially circular cross section;
c) differentially quenching said molten fibers to form crimped monocomponent fibers having a substantially circular cross section;
d) depositing said crimped monocomponent fibers upon a forming surface to form a nonwoven web material; and thereafter
e) bonding said nonwoven web material with heat and pressure to form a pattern of substantially continuous bonded areas defining a plurality of discrete unbonded areas, and wherein said nonwoven material has an unbonded area of from about 85 percent to about 50 percent.

2. The process of claim 1 further comprising the step of providing upon said forming surface a plurality of uncrimped fibers before the step of depositing said crimped fibers.

3. The process of claim 2 wherein said fiber forming thermoplastic polymer composition is a random copolymer of olefins and further wherein said uncrimped fibers comprise polypropylene.

4. The process of claim 3 wherein said fiber forming thermoplastic polymer composition is a random copolymer of propylene and ethylene.

5. The process of claim 4 further comprising the step of subjecting the nonwoven material to a stretching force after said bonding step.

6. The process of claim 5 wherein said stretching force is a 5 percent to 15 percent longitudinal stretching force.

7. A disposable article comprising:
an inner body contacting side and an outer non-body contacting side,
a hook material, and
a nonwoven loop material, wherein said loop material comprises at least a portion of said outer non-body contacting side, and further wherein said nonwoven loop material comprises a plurality of helically crimped continuous monocomponent fibers having a substantially circular cross section.

8. The disposable article of claim 7 wherein said nonwoven loop material comprises first and second plane surfaces, wherein said first plane surface comprises a majority of said uncrimped fibers and said second plane surface comprises a majority of said crimped fibers, and further wherein said second plane surface is exposed on said outer non-body contacting side of said article.

9. The disposable article of claim 8 wherein said crimped fibers comprise a random copolymer of propylene and ethylene and wherein said uncrimped fibers comprise polypropylene.

10. The disposable article of claim 8 further comprising a tab and wherein said hook material is located on said tab, and further wherein said tab and said hook material are adapted to be superposable and engagable with said loop material.

11. The disposable article of claim 9 further comprising a tab and wherein said hook material is located on said tab, and further wherein said tab and said hook material are adapted to be superposable and engagable with said loop material.

12. The disposable article of claim 10 wherein said loop material comprises on its surface a point unbonded bond pattern, said point unbonded bond pattern comprising a plurality of discrete unbonded areas defined by substantially continuous bonded areas.

13. The disposable article of claim 10 wherein said loop material comprises on its surface a point bonded bond pattern, said point bonded bond pattern comprising a plurality of discrete bonded areas separated by substantially unbonded areas.

14. The disposable article of claim 11 wherein said loop material comprises on its surface a point unbonded bond pattern, said point unbonded bond pattern comprising a plurality of discrete unbonded areas defined by substantially continuous bonded areas, wherein said unbonded areas comprise about 85 to about 50 percent of said second plane surface of said nonwoven loop material.

15. A disposable diaper comprising: a body contacting liner, an outer cover, an absorbent core disposed between said liner and said outer cover, and a mechanical fastening system, said mechanical fastening system comprising a nonwoven loop material and a tab comprising a hook material, said nonwoven loop material comprising at least a portion of said outer cover and having a first plane surface comprising a majority of uncrimped fibers and a second plane surface comprising a majority of helically crimped continuous monocomponent fibers having a substantially circular cross section, and wherein said second plane surface of said nonwoven loop material is exposed.

16. The disposable diaper of claim 15 wherein said crimped monocomponent fibers comprise a random copolymer of propylene and ethylene and said uncrimped fibers comprise polypropylene.

17. The disposable diaper of claim 16 wherein said loop material comprises on a surface a point bonded bond pattern, said point bonded bond pattern comprising a plurality of discrete bonded areas separated by substantially unbonded areas.

18. The disposable diaper of claim 16 wherein said loop material comprises on a surface a point unbonded bond pattern, said point unbonded bond pattern comprising a plurality of discrete unbonded areas defined by substantially continuous bonded areas.

19. The disposable diaper of claim 18 wherein said unbonded areas comprise about 85 to about 50 percent of said second plane surface of said nonwoven loop material.
